(19) United States
(12) Patent Application Publication
(10) Pub. No.: US 2004/0191460 A1
(43) Pub. Date: Sep. 30, 2004

(54) Use of an adhesive tape for masking in painting and decorating applications

(75) Inventor: Christof-Gottfried Hoelger, Hohberg (DE)

Correspondence Address: WILLIAM GERSTENZANG, NORRIS, MCLAUGHLIN & MARCUS, P.A., 220 EAST 42ND STREET, 30TH FLOOR, NEW YORK, NY, 10017, US

(73) Assignee: tesa AG, Hamburg (DE)

(21) Appl. No.: 10/355,934

(22) Filed: Jan. 31, 2003

(30) Foreign Application Priority Data
May 28, 2002 (DE) DE 102 23 632.1

(51) Int. Cl. B32B 3/02; B32B 7/12; B32B 31/04; B05D 1/32; B05D 5/00

(52) U.S. Cl. 428/43; 156/247; 156/264; 428/343; 428/353; 428/354; 427/282

(57) ABSTRACT

The use of an adhesive tape for masking during painting and decorating applications, having a film backing material in which a tear can be propagated transversely with respect to the direction from which individual lengths of the tape are taken, on one side of said backing material an adhesive has been applied, the adhesive tape being colored and/or nontransparent and one or both longitudinal edges of the adhesive tape having over the entire area notches having a width of less than 1000 μm and a depth of less than 100 μm, the notches being irregularly arranged and of differing depth.

The present invention relates to the use of an adhesive tape for masking in painting and decorating applications, comprising a tear-propagating film backing material to one side of which an adhesive has been applied.

### BACKGROUND OF THE INVENTION

Self-adhesive masking tapes for painting and decorating applications, referred to below as adhesive masking tape, are required to display a number of important properties in order to meet the particular requirements imposed on them. These properties, in a list which makes no claim to completeness, include low thickness, high tensile strength (ultimate tensile stress strength), good stretchability (elongation at break), a sufficient but not excessive bond strength, the capacity for residue-free detachment after the stresses of the actual application, resistance to paint penetration, resistance to moisture, a measured bond strength to its own reverse face, a sufficiently high water resistance, and good hand tearability.

A force of from 12 to 28 N/cm at an elongation of between 10% and 150% allows the adhesive tapes to be bonded to curved surfaces without creases and to form a planar bond on spherical substrates.

In these cases, the adhesive tape must neither undergo partial detachment from the substrate nor undergo necking (necking-in) at the stretched edges, so as to avoid instances of paint running behind it and of nonuniform paint edges.

While some of the properties can be attributed to the adhesive or other functional layers of the adhesive masking tape, the stretchability, tensile strength, and hand tearability are based essentially on the physical properties of the backing material used.

For adhesive masking tapes it is therefore preferred to use impregnated paper backings, especially those equipped with a defined tensile strength by virtue of the basis weight of the backing, the nature of the pulp used, the degree of freeness, and certain chemical auxiliaries, and with a defined stretchability by virtue of special process steps such as creping or the Clupak process.

Restrictions on the use of paper backings arise frequently on the basis of the strongly reduced strength of the paper backings under the effects of moisture, including effects in the outdoor sector, for example; additionally, paper backings are disadvantageous in cases where the quality of the paint edge necessitates a very low thickness of backing.

Embossed PVC films do find application as masking tape in the decorating sector; the film exhibits an excellent moisture resistance, which is especially useful for use outdoors. The embossing of the film ensures its hand tearability and makes it significantly easier to use.

Furthermore, thin films are used as so-called plaster tapes: the adhesive tapes can be torn into by hand. Owing to the absence of dimensional stability during disbanding, thin films with a low tensile strength, high stretch, and the resulting tendency toward neck-in are disadvantageous; moreover, they are highly stretched at the tear-off site and have a highly deformed, corrugated torn edge, which is likewise disadvantageous in the context of use as a painting or decorating tape.

A tensile strength in the longitudinal (machine) direction which is in the range from 12 to 30 N/cm allows easy tearing by hand. However, such tensile strengths are already so low that the removal of the adhesive tape after use without tearing is problematic.

In the painting sector, adhesive tapes with film backings (for example, tesa ® 4104) are used as painting tapes, especially when exacting requirements are imposed on the paint edge. Owing to the lack of hand tearability, it is necessary during application to use auxiliary means in order to remove a length of tape.

For these applications, films of which a length can be removed effectively by hand, owing to their low stretch and tensile strength, are also known as backings for adhesive tapes (tesa ® 7164, fineline range). These films, however, are very expensive. DE 43 18 277 C1 disclosed the use of jagged cutters for the longitudinal cutting of double-face self-adhesive tapes with PP backings, which find use in particular as carpetlaying tape.

The jags of the jagged cutter preferably have a height of from 0.3 to 6 mm, in particular from 0.4 to 1 mm. As a result of the jaggedness thereby produced in the cut edge, the hand tearability of the adhesive tape is enhanced. For use in the painting and decorating sector, such jagged edges are of course unsuitable owing to the unwanted reproduction of the jags on the paint edge. Moreover, such tapes have a tendency towards soiling during storage.

Finally, the jagged cutters are costly and inconvenient to manufacture, and hence the products produced using them are also expensive.

It is an object of the invention to provide an adhesive tape for masking during painting and decorating applications, comprising a film backing material to which an adhesive has been applied, the adhesive tape being free of the prior art drawbacks illustrated.

### SUMMARY OF THE INVENTION

The invention accordingly provides for the use of an adhesive tape for masking during painting and decorating applications, having a film backing material in which a tear can be propagated transversely with respect to the direction from which individual lengths of the tape are taken, on one side of said backing material an adhesive has been applied, the adhesive tape being colored and/or nontransparent and one or both longitudinal edges of the adhesive tape having over the entire area notches having a width of less than 1000 μm and a depth of less than 100 μm, the notches being irregularly arranged and of differing depth.

### BRIEF DESCRIPTION OF THE DRAWINGS

FIG. 1 illustrates the notches on one longitudinal edge of the adhesive tape used in the practice of the invention.

FIG. 2. is a microscopic view of the rough cut edge of the adhesive tape of the Example.

### DETAILED DESCRIPTION

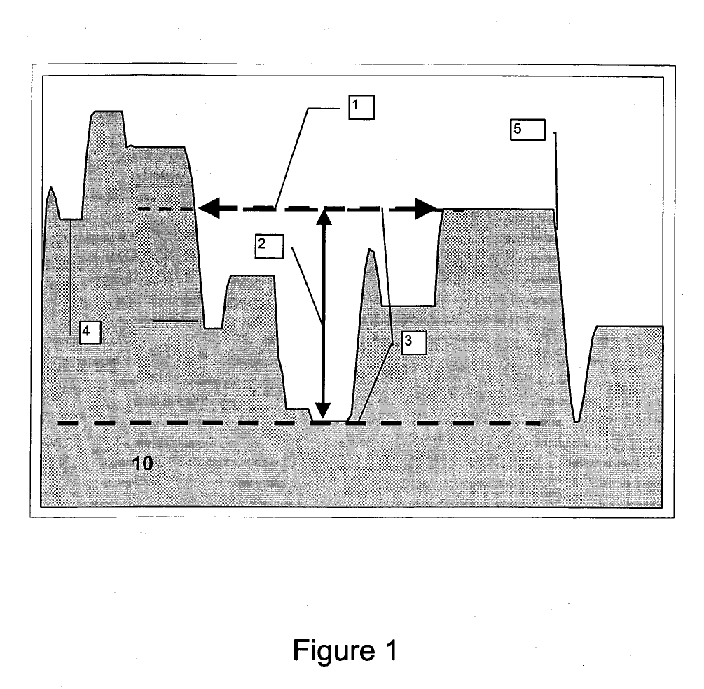

Notching in the border area of the adhesive tape 10, in other words at the cut edge 5, has a curved or zigzag course which is uneven, exhibiting local minima and local maxima, and is described here by means of a width 1 and an associated depth 2 (see FIG. 1). The depth 2 of a notch is used here to refer to the distance between two lines running parallel in the longitudinal direction of the adhesive tape, with one line passing through a minimum and the second through a maximum. In the case of a uniformly sinusoidal course, one line passes in each case through two or more adjacent local minima 4 or maxima.

In the case of an irregular course this is normally not the case: the depth of a notch is described by a line which passes only through one single maximum. The width occupied by a notch is the distance between the points of intersection of the straight lines through a maximum, on the one hand, and with the longitudinal edge of the adhesive tape, on the other. The depth of a notch having a certain width relates naturally to the minimum with the greatest distance between the points of intersection.

In a first advantageous embodiment of the invention the notches are present only on one of the longitudinal edges.

More preferably, larger and smaller notches are present, the larger notches having with particular preference a depth of from 15 to 100 μm and the smaller notches having with particular preference a depth of from 5 to 15 μm.

In another advantageous embodiment of the invention the larger notches are arranged with a frequency of 1 to 10/mm of edge and/or the smaller notches are arranged with a frequency of 5 to 30/mm of edge.

In a further advantageous embodiment of the invention the tear propagation forces are on average less than 10 N, in particular less than 1 N.

The notches ensure improved hand tearability in the transverse direction (relative to the direction in which the adhesive tape extends) without restricting the stability that is needed for the application.

The adhesive tape can be torn off by hand very easily, allowing the user to tear off the tape without exerting a high force and without the assistance of tools such as scissors or cutters following application. The result is a considerable time saving in the processing operation.

However, the notches are sufficiently small that the requirements in terms of the decorating result, in respect of the paint edge, are met.

The irregularity of the notches means that they are less visible than, for example, an edge produced with a jagged cut.

Surprisingly, and completely unexpectedly for the skilled worker, an adhesive tape with a tear-propagating film backing material which in the edge area, on a microscopic scales, has notches with a width of less than 1000 μm and depth of less than 100 μm precisely exhibits the properties required for use as an adhesive masking tape.

As a material for the film it is preferred to use BOPP, MOPP, PVC or PET, which in a particularly advantageous embodiment of the invention additionally has a thickness of from 20 to 100 μm, in particular from 30 to 50 μm.

All of the films listed can be used as backing film in accordance with the invention. One advantageous embodiment of the invention is represented by a film which is colored and/or nontransparent.

In another advantageous embodiment of the invention the tear propagation force of the film, as described by the tear propagation force determined on trouser-shaped test specimens (EN ISO 13937-2 with a 100 mm/min advance speed), is advantageously <10 N, in particular less than 1 N.

One outstanding embodiment of the invention is then that wherein the film has been provided with a pressure sensitive adhesive.

In another advantageous embodiment of the invention the adhesive application rate is from 15 to 30 g/m².

The adhesive of the adhesive tapes of the invention may comprise a self-adhesive from the group of natural rubbers or of synthetic rubbers or of any desired blend of natural rubbers and/or synthetic rubbers, the natural rubber or rubbers being selectable in principle from all available grades such as, for example, crepe, RSS, ADS, TSR or CV grades, depending on the required level of purity and viscosity, and the synthetic rubber or rubbers being selectable from the group consisting of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate (EVA) copolymers, and polyurethanes and/or blends thereof.

With further preference, in order to improve the processing properties, thermoplastic elastomers may be added to the rubbers in a weight fraction of from 10 to 50% by weight, based on the total elastomer fraction.

As representatives, mention may be made at this point in particular of the especially compatible styrene-isoprene-styrene (SIS) and styrene-butadiene-styrene (SBS) grades.

As tackifier resins it is possible without exception to use all known tackifier resins and all tackifier resins described in the literature. As representatives, mention may be made of the rosins, their disproportionated, hydrogenated, polymerized and esterified derivatives and salts, the aliphatic and aromatic hydrocarbon resins, terpene resins, and terpene-phenolic resins. Any desired combinations of these and further resins may be used in order to tailor the properties of the resulting adhesive. Express reference may be made to the depiction of the state of the art in the “Handbook of Pressure Sensitive Adhesive Technology” by Donatas Satas (van Nostrand, 1989).

Crosslinking is advantageous for improving the removability of the adhesive tape following application, and may be effected thermally or by irradiation with UV light or electron beams.

For the purpose of thermally induced chemical crosslinking it is possible to use all known heat-activatable chemical crosslinkers such as accelerating sulfur systems or sulfur donor systems, isocyanate systems, reactive melamine resins, formaldehyde resins and (optionally halogenated) phenol-formaldehyde resins or reactive phenolic resin systems or diisocyanate crosslinking systems with the corresponding activators, epoxidized polyester resins and acrylate resins, and combinations thereof.

The crosslinkers are preferably activated at temperatures above 50° C., in particular at temperatures from 100° C. to 160° C., with very particular preference at temperatures from 110° C. to 140° C.

Thermal excitation of the crosslinkers may also take place by IR radiation or by means of high-energy alternating fields.

It has proven particularly advantageous to use an adhesive based on acrylate hotmelt which has a K value of at least 20, in particular more than 30, obtainable by concentrating a solution of such an adhesive to give a system which can be processed as a hotmelt.

Concentration may take place in appropriately equipped tanks or extruders; particularly when devolatilization accompanies the concentration process, a devolatilization extruder is preferred.

An adhesive of this kind is specified in DE 43 13 008 A1, the content of which is hereby incorporated by reference to become part of this disclosure and invention. In an intermediate step, the solvent is removed completely from the acrylate compositions prepared in this way.

Additionally, further volatile constituents are removed. After coating from the melt, these compositions contain only minimal fractions of volatile constituents. It is therefore possible to adopt all of the monomers/formulations claimed in the patent set out above. A further advantage of the compositions described in the patent is regarded as being the fact that they have a high K value and thus a high molecular weight. The skilled worker is aware that systems with higher molecular weights can be crosslinked more efficiently. There is a corresponding reduction in the fraction of volatile constituents.

The solution of the composition may contain from 5 to 80% by weight, in particular from 30 to 70% by weight, of solvent(s).

Preference is given to using commercially customary solvents, especially low-boiling hydrocarbons, ketones, alcohols and/or esters.

Further preference is given to using single-screw, twin-screw or multi-screw extruders having one or, in particular, two or more devolatilizing units.

Benzoin derivatives may be copolymerized into the adhesive based on acrylate hotmelt, such as benzoin acrylate or benzoin methacrylate, acrylic or methacrylic esters, for example. Benzoin derivatives of this kind are described in EP 0 578 151 A1.

Alternatively, the adhesive based on acrylate holtmelt may have been crosslinked chemically.

In one particularly preferred embodiment the self-adhesives used are copolymers of (meth)acrylic acid and esters thereof having 1 to 25 carbon atoms, maleic, fumaric and/or itaconic acid and/or their esters, substituted (meth)acrylamides, maleic anhydride and other vinyl compounds, such as vinyl esters, especially vinyl acetate, vinyl alcohols and/or vinyl ethers.

The residual solvent content ought to be below 1% by weight.

An adhesive which is found particularly suitable is a low molecular mass acrylate holtmelt pressure sensitive adhesive as supplied under the name acResin UV or Acronal ®, especially Acronal ® DS 3458, by BASF. This low-K adhesive acquires its application-compatible properties by virtue of a final crosslinking which is initiated chemically by radiation.

In order to ensure not only sufficient adhesion but also ease of unwind and redetachability after application, the bond strength to steel should be situated in the range from 2.0 to 4.8 N/cm.

Where appropriate, a release varnish may be applied to the reverse face in order to improve the unwind properties.

In certain cases, conversely, the reverse face may be treated with a corona or with a varnish for the purpose of improving the adhesion of an ink to the reverse face.

It is advantageous to use a primer layer between backing film and adhesive for the purpose of improving the adhesion of the adhesive to the film and hence of allowing the system to be removed again without residue after use.

Descriptions of the adhesives commonly used for adhesive tapes, and also of release varnishes and primers, can be found, for example, in the “Handbook of Pressure Sensitive Adhesive Technology” by Donatas Satas (van Nostrand, 1989).

The content of said book is hereby incorporated by reference to become part of this disclosure and invention.

With further preference, as a result of the adhesive and/or of an applied primer, the adhesive tape is colored (for example, white) and/or is optically nontransparent.

With further preference, the film is printed on the reverse face or on the adhesive side, especially when only one longitudinal edge has been provided with the notches, in order, for example, to draw the attention of the user of the adhesive tape to the tearable edge.

The adhesive tape possesses low thickness, high tensile strength (ultimate tensile stress strength), good stretchability (elongation at break), a sufficient but not excessive bond strength, the capacity for residue-free detachment after the stresses of the actual application, resistance to paint penetration, resistance to moisture, a measured bond strength to its own reverse face, a sufficiently high water resistance, and excellent hand tearability.

The latter in particular is optimized to outstanding effect by virtue of the appropriate choice of corresponding notches, so that film adhesive tapes can be used for said purpose and not just adhesive tapes having a paper backing, as was hitherto the case. The intention of the text below is to illustrate the invention with reference to an example without wishing to restrict the invention unnecessarily.

### Example

A transparent PVC film 38 μm thick was coated with a water-based primer. The application rate of the primer after subsequent drying was 0.6 g/m². A rubber adhesive dispersed in petroleum spirit was then applied and the petroleum spirit was removed in the subsequent drying operation. The application rate of the adhesive was 23 g/m².

The adhesive tape was composed of natural rubber, a blend of resins and fillers. The presence of TiO₂ among the fillers gave the adhesive a white coloration which also determined the color of the masking tape. From this material, rolls measuring 50 mm ×33 mm with a rough cut edge were produced.

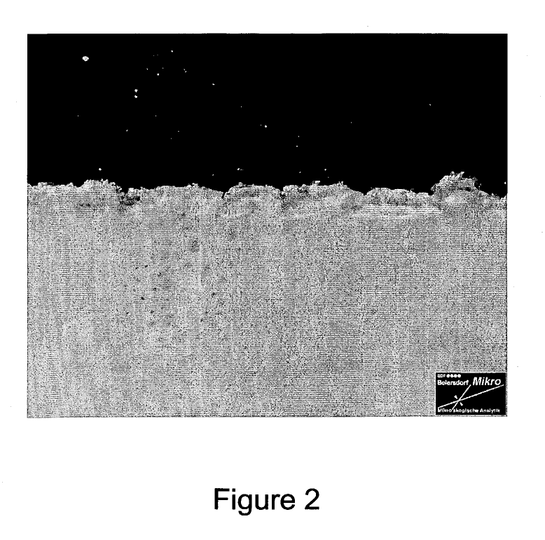

A microscopic section of the rough cut edge is shown in FIG. 2.

The lengths of the side edges of the section pictured are 2.25×1.85 mm. In the section depicted, the masking tape has eight notches with a differing depth of less than 100 μm and more than 15 μm at irregular intervals, and also a multiplicity of even smaller notches.

The material gave a bond strength on steel of 3.1 N/cm. The thickness of the masking tape as a whole was 65 μm, the ultimate tensile stress strength of the masking tape at a testing speed of 300 mm/min was 48 N/15 mm, the elongation at break was 22.5%, the unwind force at a take-off speed of 30 m/min was 4.7 N/cm.

Performance tests were carried out.

In these tests, strips of the masking tape were bonded to aluminum panels and overcoated with commercial paints, including emulsion paints. After different drying times the test strips were removed again and an assessment was made of the decorating result and processing properties.

The masking tape could be separated to give unit lengths, and bonded, outstandingly. The assessment indicated an excellent thin paint edge, no underuns, no paint penetration, no residues of adhesive on removal, sufficient paint adhesion, and good properties when the adhesive tape was removed.

We claim:

1. A method for masking during painting and decorating applications which comprises applying to areas of a substrate to be masked an adhesive tape having a film backing material which is tearable transversely to the direction from which individual lengths of the tape are taken, having an adhesive applied to one side, the adhesive tape being colored, or nontransparent, or both, and wherein one or both longitudinal edges of the adhesive tape is notched with notches having a width of less than 1000 μm and a depth of less than 100 μm, which notches are irregularly arranged along said one or both longitudinal edges and of differing depths.

2. The method of claim 1, wherein the notches are present on only one of the longitudinal edges.

3. The method of claim 1, wherein larger and smaller notches are present, the larger notches having a depth of from 15 to 100 μm and the smaller notches having a depth of from 5 to 15 μm.

4. The method of claim 3, wherein the larger notches are arranged with a frequency of from 1 to 10/mm of edge, or the smaller notches are arranged with a frequency of from 5 to 30/mm of edge, or both.

5. The method of claim 1, wherein the tear propagation forces required to tear said adhesive tape are on average less than 10 N.

6. The method of claim 5 wherein said tear propagation forces are on average less than 10 N.

7. The method of claim 1, wherein said backing material is selected from the group consisting of PVC, BOPP, MOPP and PET.

8. The method of claim 1, wherein the film has a thickness of from 20 to 100 μm.

9. The method of claim 8, wherein the film has a thickness of from 30 to 50 μm.

10. The method of claim 1, wherein the film has printing on the reverse.

11. The method of claim 1, wherein the adhesive is anchored to the film by a primer.

12. The method of claim 1, wherein the adhesive tape has printing between the film and the adhesive layer.

13. The method of claim 1, wherein one or more of the adhesive, primer, and film are colored, or nontransparent or both.
